(19) United States
(12) Patent Application Publication
(10) Pub. No.: US 2010/0285267 A1
(43) Pub. Date: Nov. 11, 2010

(54) Wall Art Apparatus and Method of Installation

(76) Inventor: E. Allan Howze, Chicago, IL (US)

Correspondence Address: HURLEY STANNERS, LLC, 1011 LAKE STREET, OAK PARK, IL, 60301-1137, US

(21) Appl. No.: 12/778,059

(22) Filed: May 11, 2010

Related U.S. Application Data
(60) Provisional application No. 61/176,942, filed on May 11, 2009.

(51) Int. Cl. B29C 44/04; A47G 1/12

(52) U.S. Cl. 428/99; 264/45.1

(57) ABSTRACT

An alternative method of affixing molded sculptural pieces to a wall is disclosed. In one embodiment, the procedure involves setting a screw into the bottom half of a mold before resin is poured in, thereby embedding the screw in the finished molded piece. This allows the piece to be more accurately placed on a wall without adding further hardware to the sculpture or the wall.

### FIELD OF THE INVENTION

The present invention relates generally to a method and apparatus for quick installation of molded art pieces to wall surfaces, and more specifically relates to an apparatus, kit, and method of installing art that can be hung from a wall or other substrate.

### BACKGROUND OF THE INVENTION

The resin molding process is a long-established procedure. Mounting resin, glass, paper or wood pieces on walls, however, can be challenging. Present mounting applications require attaching hardware to the piece after it is made, more hardware fastened to the wall to hold the piece, and tools to accomplish these jobs.

### SUMMARY OF THE INVENTION

The present invention relates to one or more of the following features, elements or combinations thereof. A method of affixing molded sculptural pieces to a wall is disclosed. In one embodiment, the procedure involves partially drilling a screw into the bottom half of a mold before resin is poured in, thereby embedding the screw in the finished molded piece. This allows the piece to be accurately placed on a wall without adding further hardware to the sculpture or the wall.

### BRIEF DESCRIPTION OF THE DRAWINGS

FIGS. 1-3 are perspective views of a lower section of a mold assembly according to one embodiment of the invention;

FIGS. 4-18 show additional perspective views of the method of forming a three-dimensional piece of mountable art according to one embodiment of the invention;

FIGS. 19-21 show perspective views of the resulting three-dimensional pieces of mountable art that can be created according to the disclosed method and process; and

FIGS. 22-27 show additional perspective views of the resulting three-dimensional pieces of mountable art that can be created according to the disclosed method and process.

### DETAILED DESCRIPTION OF EMBODIMENTS OF THE INVENTION

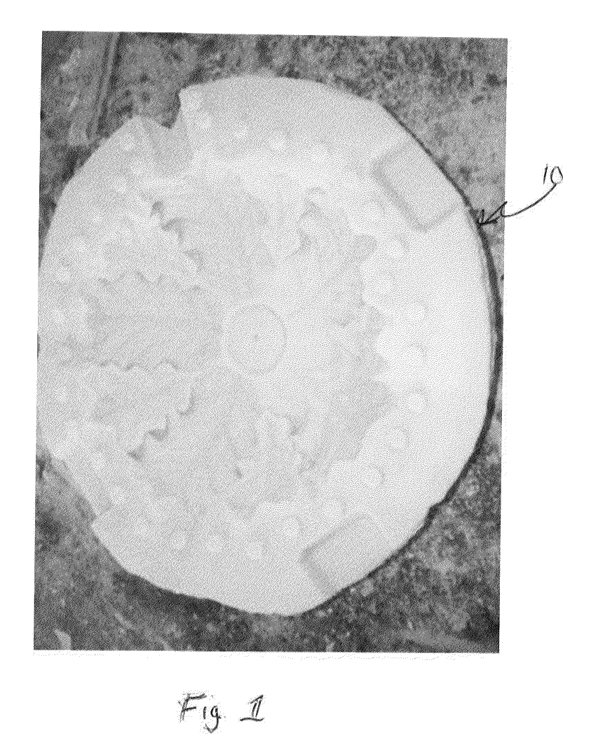

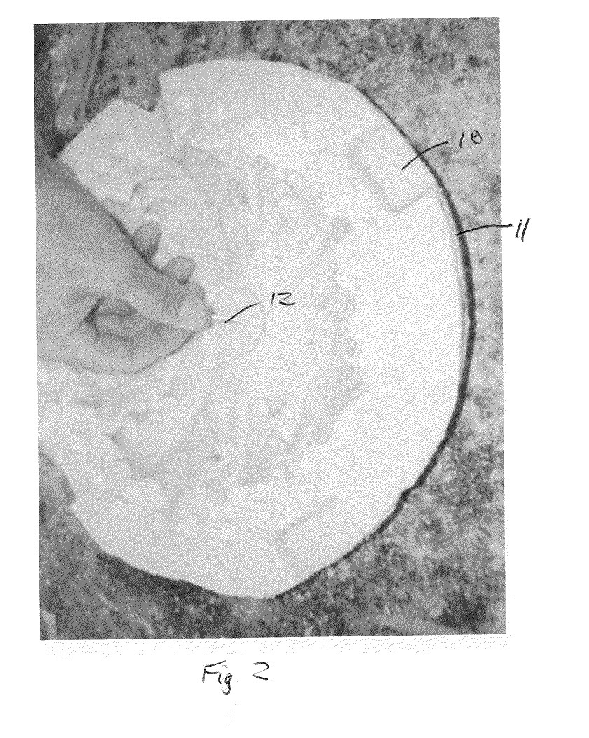

In an illustrated embodiment, a three-dimensional piece of mountable art is created from a formable material and a double-layer mold. FIG. 1 shows a lower section 10 of an inner mold. In the illustrated embodiment, lower section 10 is placed inside an outer mold 11 (visible in FIG. 2), which is hard-molded to provide additional strength in the mold process. Outer mold 11 is illustratively composed of plaster, but could alternatively be composed of #10 latex, #11 resin, wood, or any other suitable material that can hold a firm shape.

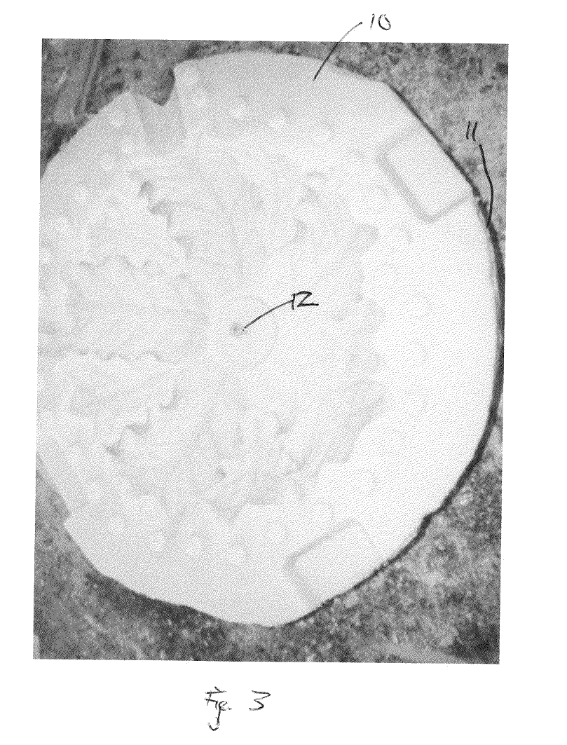

As can be seen in FIG. 2, a screw 12 can be inserted through lower section 10 and screwed (or placed otherwise) partially into outer mold 11 underneath. This may be done, for example, at approximately a 90-degree angle, as can be seen in FIG. 3. It is contemplated that nearly any length of screw may be used and even other types of fasteners may be used. However, in the disclosed embodiment, a one-inch screw is used.

It is contemplated that other types of attachment means can be used in place of the screw 12. For example, a hook-and-loop fastener, embedded magnets and/or embedded stainless steel wires that become an element in the artwork/sculpture are also contemplated as attachment means.

Turning back to the illustrative embodiment, screw 12 is not fully tightened, such that the screw head does not become flush with the bottom of the mold. Rather, screw 12 is left so that its associated screw head will be encased in the formable material—e.g. resin—that is later added.

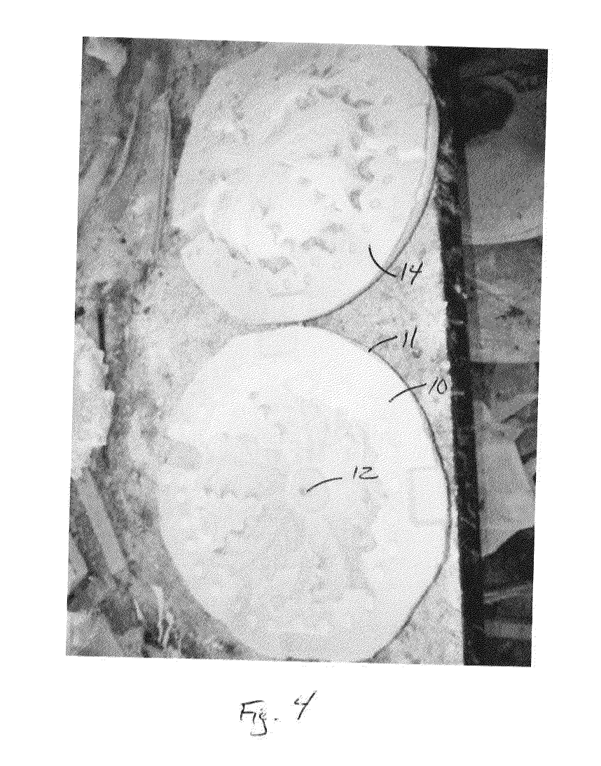

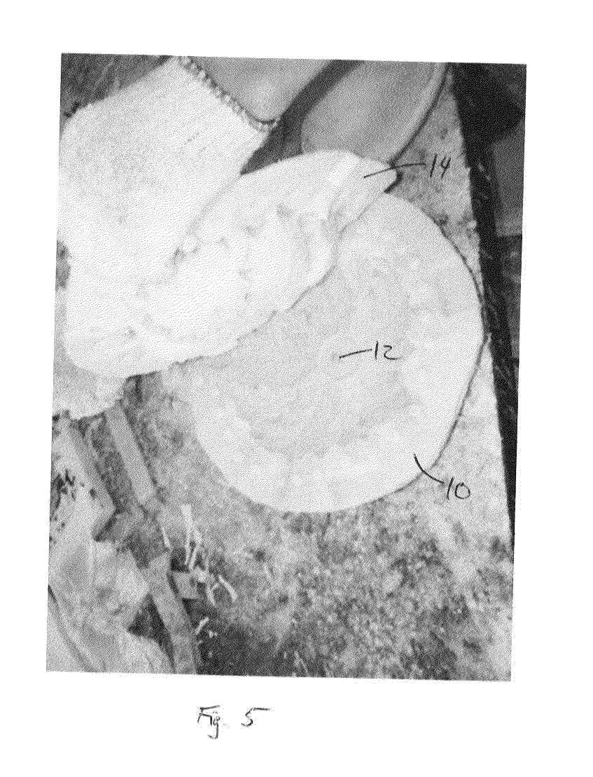

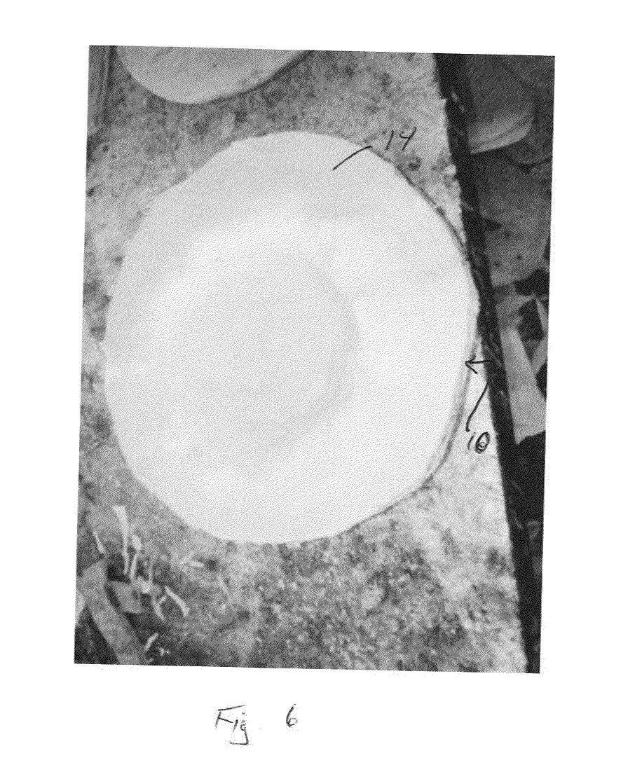

FIG. 4 shows upper section 14 of the inner mold prior to it being joined with lower section 10, and FIG. 5 shows the upper section 14 being set in place over lower section 10. FIG. 6 shows the upper section 14 engaged with lower section 10.

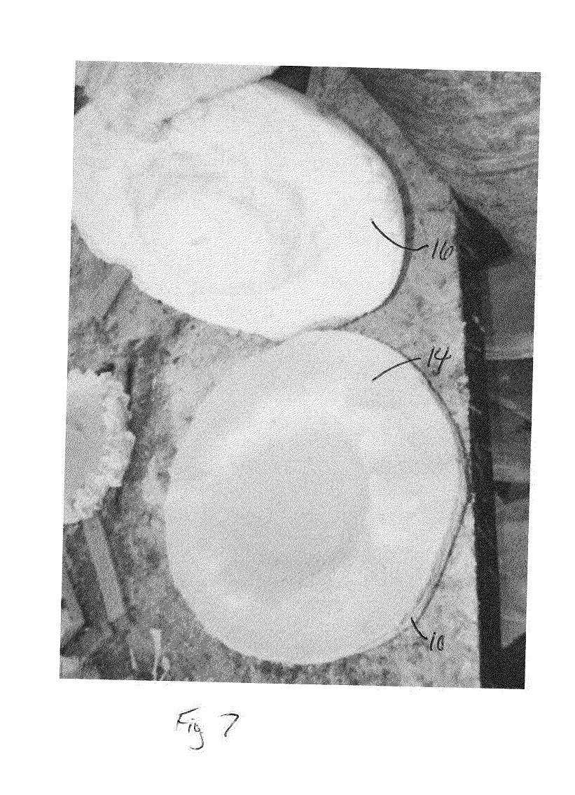

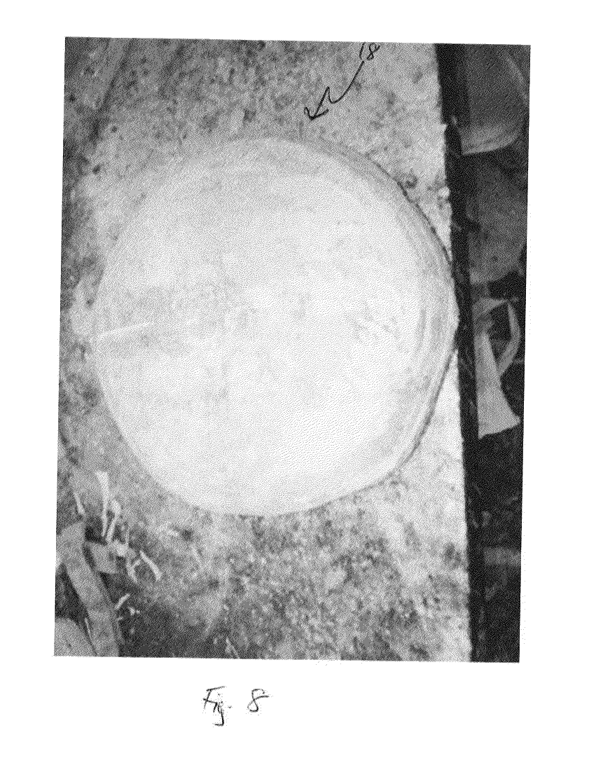

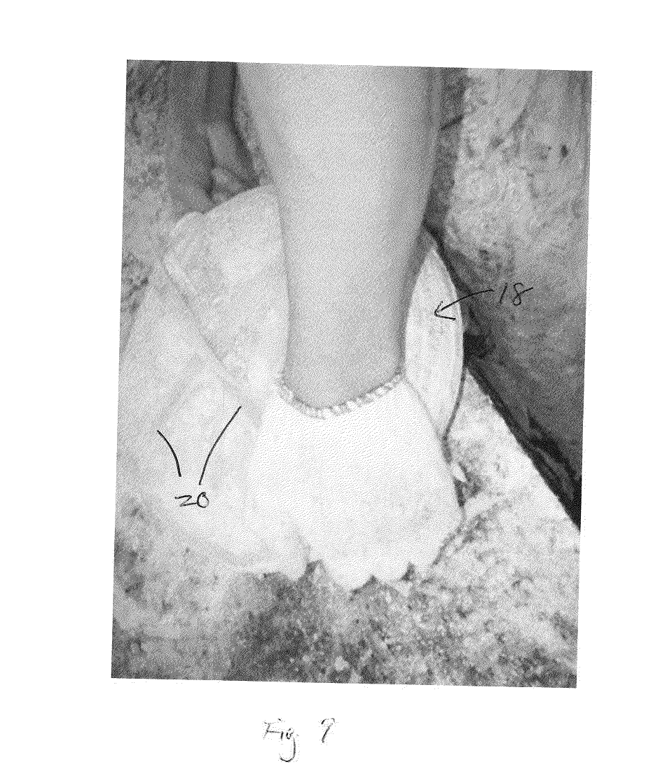

A second hard-molded outer mold 16 can be used to assist with positioning or setting upper section 14 with lower section 10 of the mold. As can be seen in FIGS. 7 and 8, second outer mold 16 is formed such that the upper 14 and lower 10 sections of the inner mold can be positioned between first and second outer mold sections 11, 16. By using outer mold sections 11, 16, inner mold sections 12, 14 can be firmly held in place against each other. The entire mold assembly 18 is then illustratively banded with rubber straps 20 to hold it together, as can be seen in FIGS. 9 and 10. As with the outer mold 11, second outer mold 16 is illustratively composed of plaster, but could alternatively be composed of #10 latex, #11 resin, wood, or any other suitable material that can hold a firm shape.

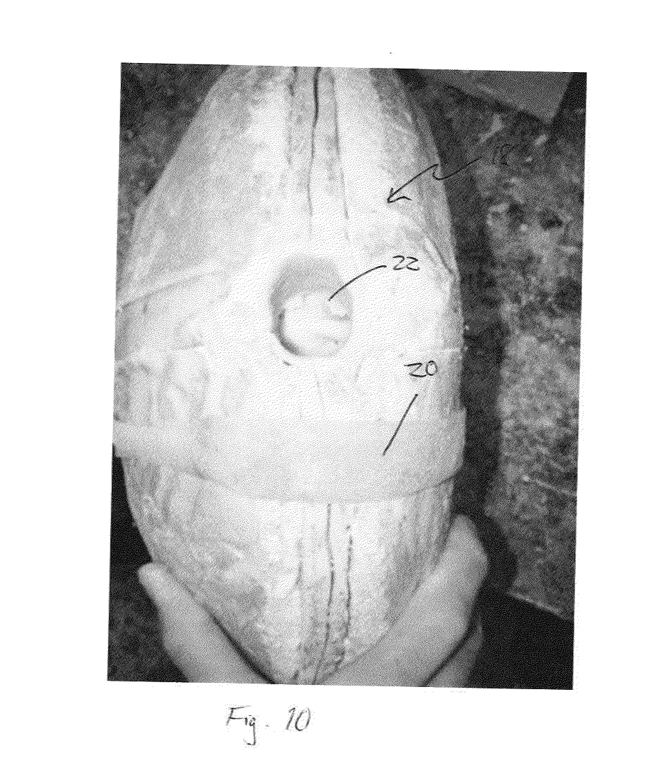

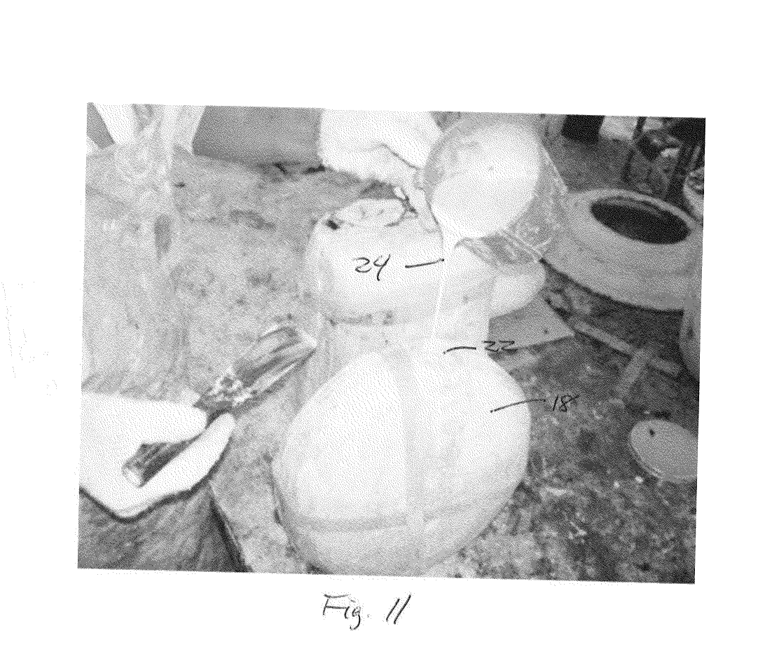

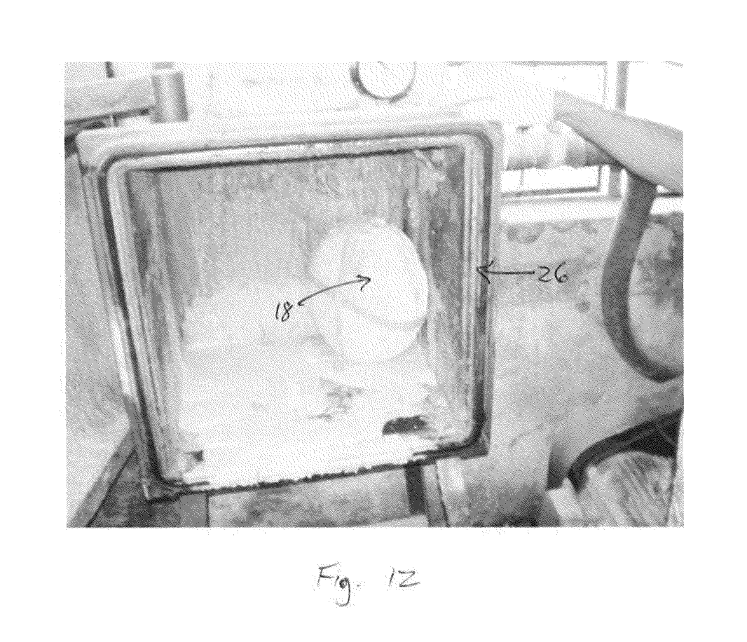

At this point, a formable material such as resin can be poured into a hole 22 formed in a portion of mold assembly 18. In the illustrative embodiment, mold assembly 18 may be held on its end and resin 24 poured through hole 22, such as shown in FIG. 11. Any bubbles that may form in the resin while it was being poured into the mold assembly 18 are ideally removed before the resin hardens. The disclosed method of removing the bubbles includes quickly placing the mold in a controlled vacuum machine 26 for ten or more seconds, as can be seen in FIGS. 12 and 13.

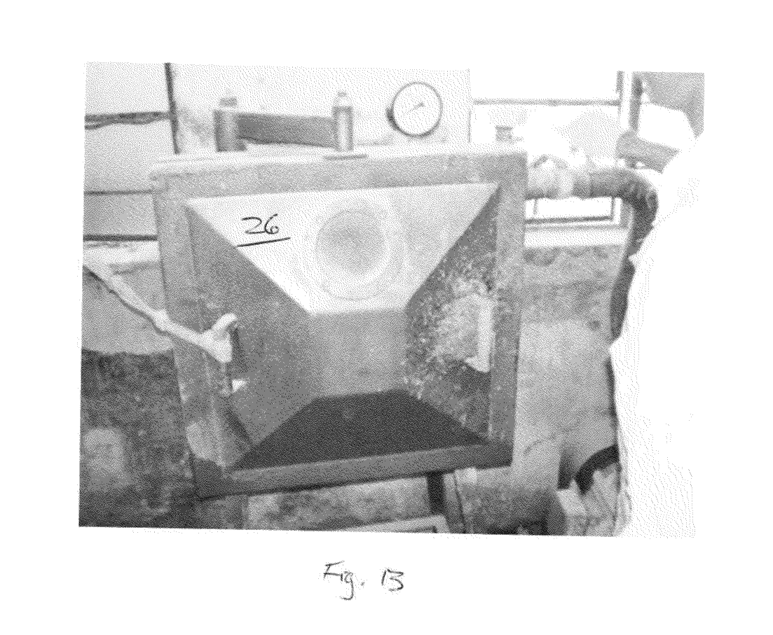

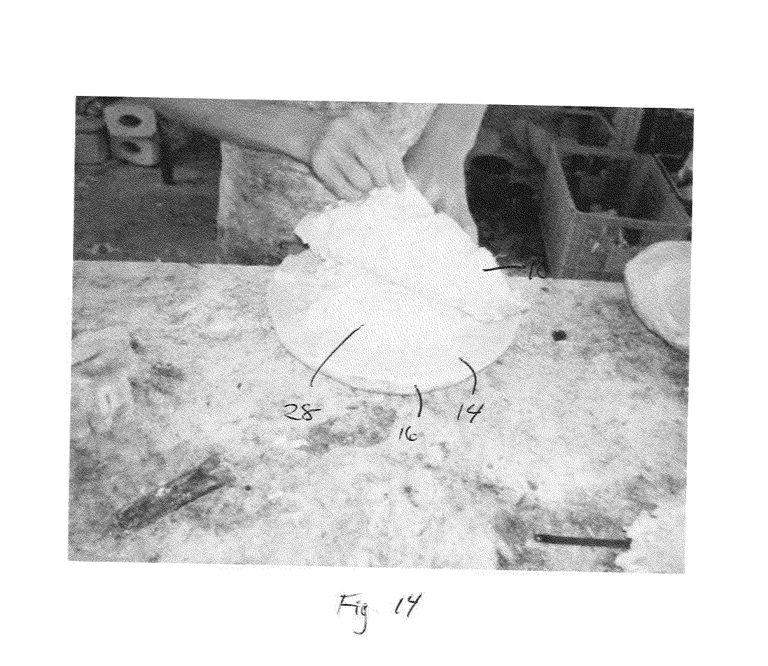

FIGS. 14, 15, 16 and 17 show the hardened resin sculpture 28 being removed from mold assembly 18. In the disclosed embodiment, excess resin is removed from the piece 28 and the piece 28 is sanded prior to being painted or covered with a desirable material, such as a metallic leafing. It should be understood that other coatings are contemplated. For example, paint, ink, pencil, and photo transfers are contemplated as coatings that can cover the sculpture 28. In another embodiment, an end consumer can purchase an unfinished product and finish it in a way desired by such end consumer.

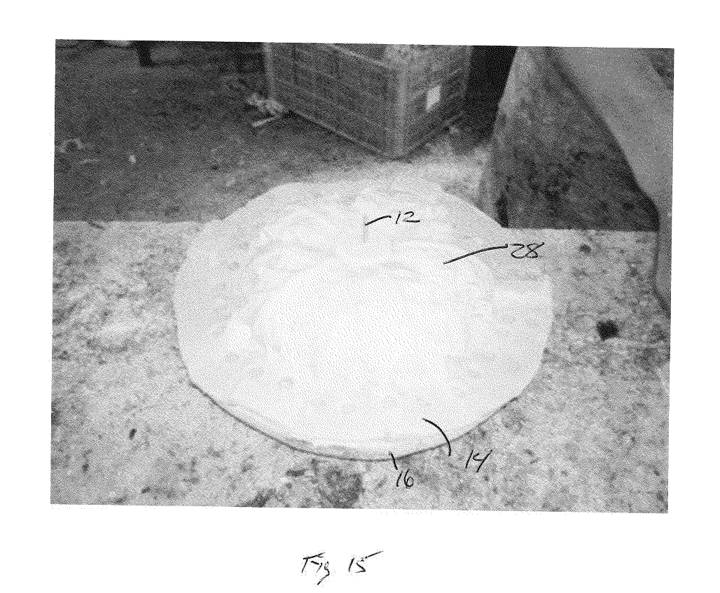

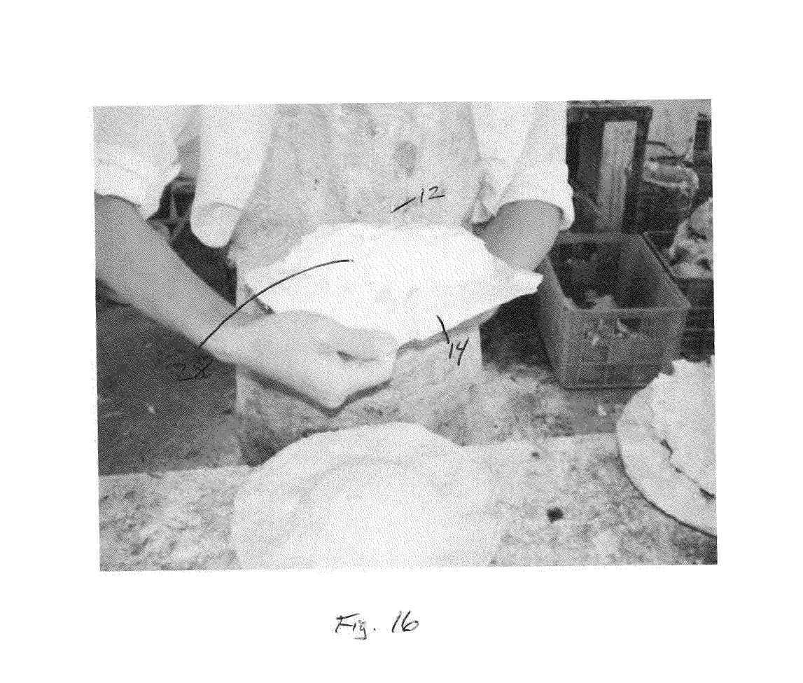

As can be seen in FIG. 17, screw 12 protrudes from the back of the sculpture 28. It can now be placed on a wall without the danger of damaging the piece or affecting the aesthetic value of the piece by adding hanging hardware. Additionally, the disclosed structure for sculpture 28 allows it to be placed in locations or on substrates that may have otherwise been difficult to use as a mount surface. Moreover, the disclosed structure for sculpture 28 allows it to be mounted without the use of tools. In essence, the sculpture itself functions as the screw head, permitting the sculpture to be screwed into a substrate without even the use of a screwdriver.

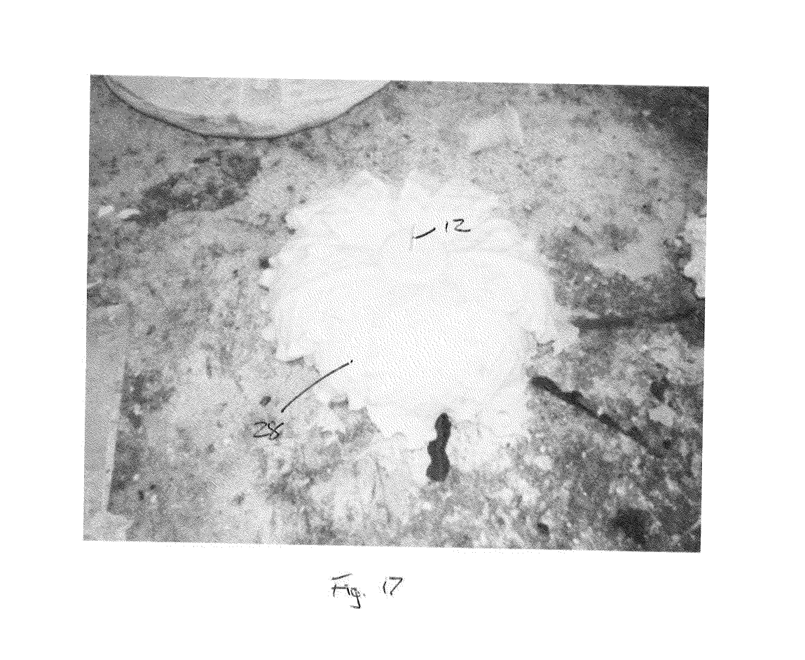

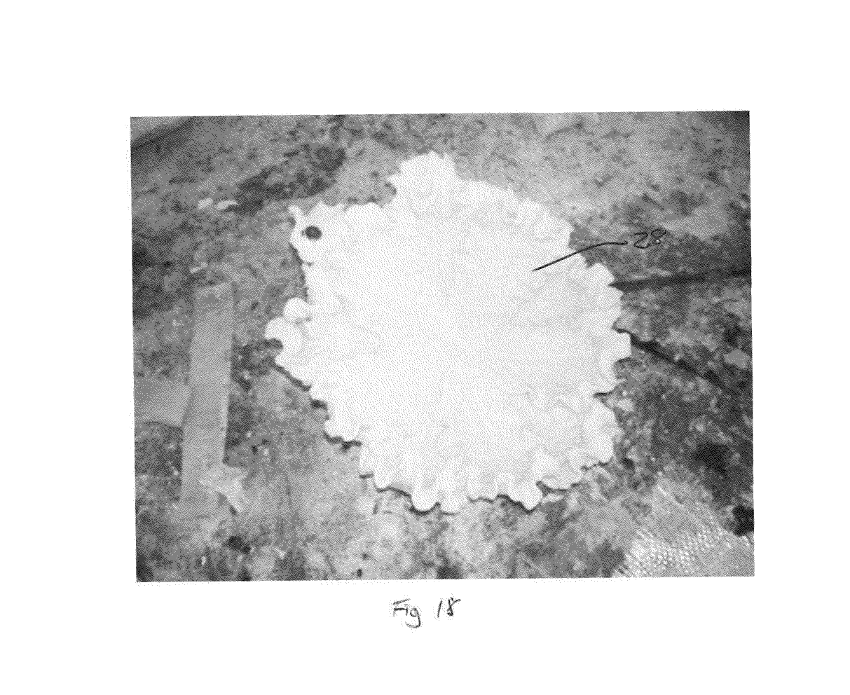

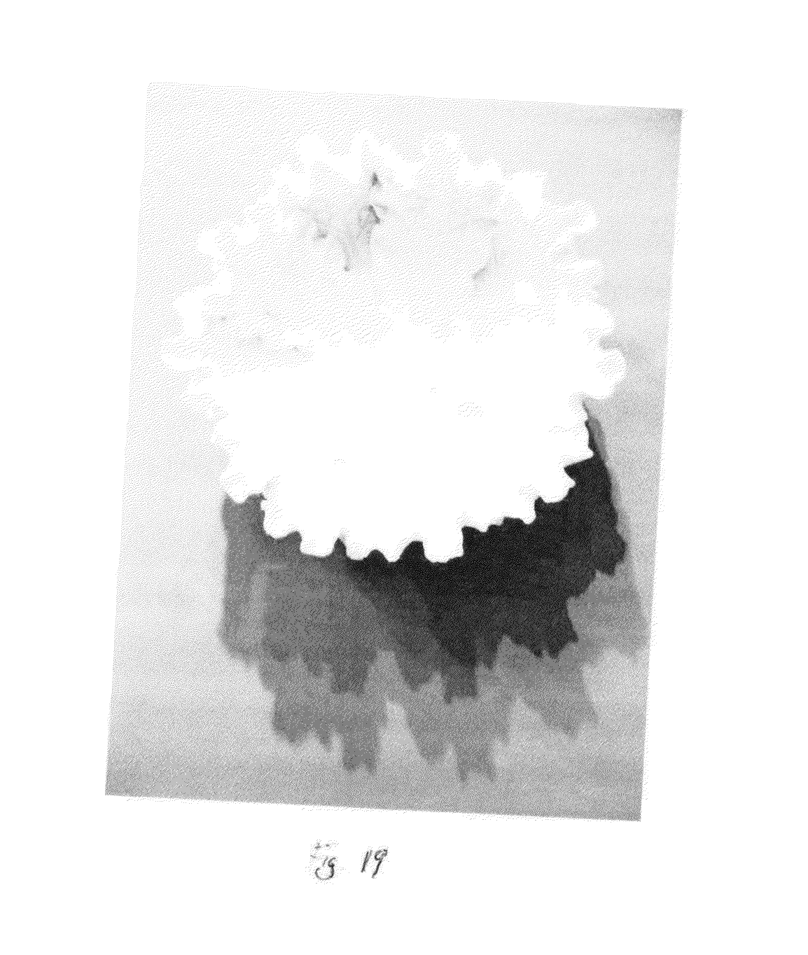

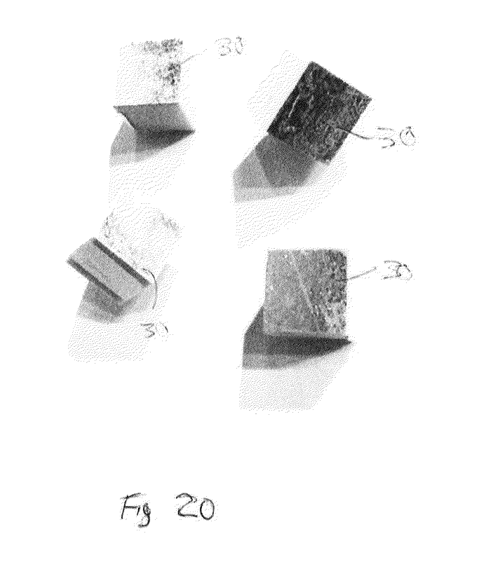

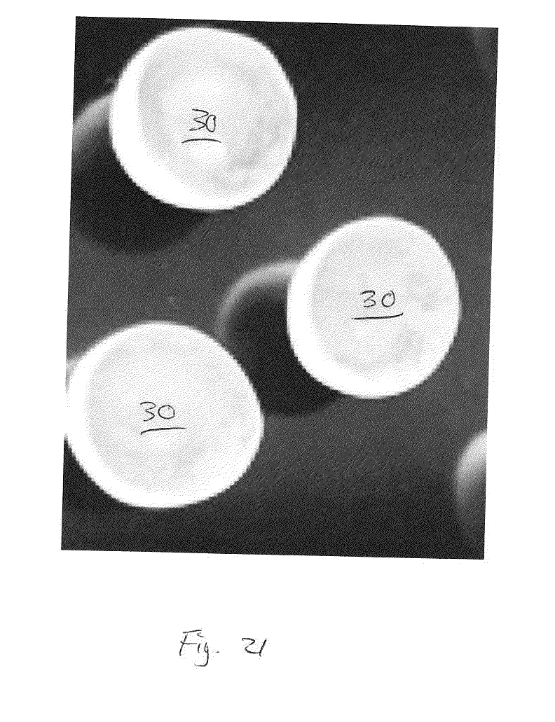

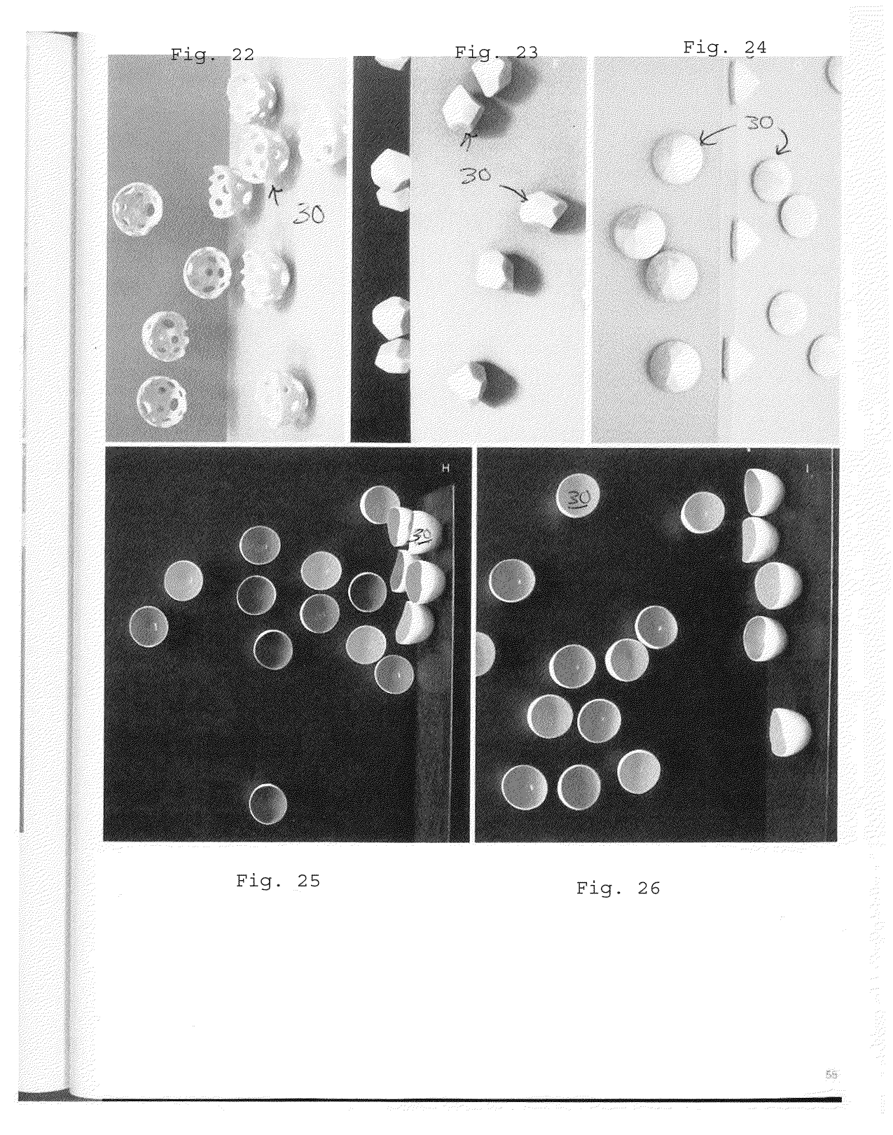

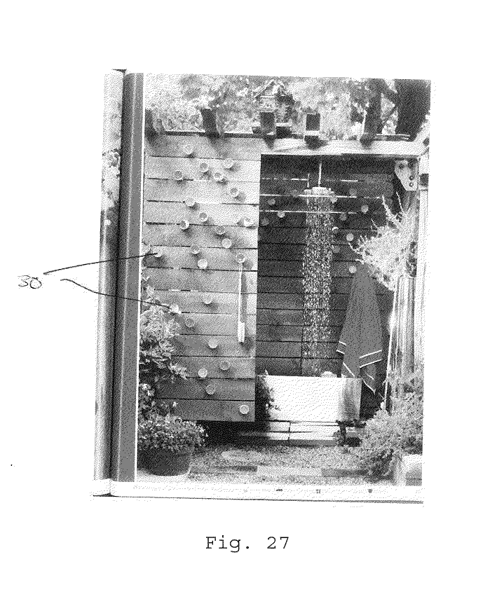

A view of a finished product can be seen in FIG. 19. It is contemplated that a virtually unlimited range of sculptures and molded items may be formed in this manner. Additional types of molded items can be formed as instructed above and mounted in the manner described. For example, a solid shape or any other type of geometric shape may be formed for mounting in this manner. In the examples shown in FIGS. 20-26, sculptures 30 are formed from the above-disclosed process, with fasteners (e.g. screws) positioned in the molding process. Such sculptures 30 may include, for example, perforated objects such as that shown in FIG. 22, geometric shapes such as those shown in FIGS. 23-24, egg shell shapes such as those shown in FIGS. 25-26, and even shapes of animals, such as fish. In the latter embodiment, it is contemplated that the animal (e.g. a fish shape) may come in various sizes, including dimensions up to six or more inches. Certain shapes, such as particularly large or heavy shapes, may require stronger fasteners. In the screw embodiments, such fasteners may be, for example, a one inch long stainless steel screw.

FIG. 27 illustrates an artistic look that can be accomplished using the present invention. As can be seen the substrate may be a fence or a part of a house, and the sculptures 30 may serve a dual purpose, such as serving as both a hanger and an aesthetically pleasing element.

While the disclosure is susceptible to various modifications and alternative forms, specific exemplary embodiments thereof have been shown by way of example in the drawings and have herein been described in detail. It should be understood, however, that there is no intent to limit the disclosure to the particular embodiments disclosed, but on the contrary, the intention is to cover all modifications, equivalents, and alternatives falling within the spirit and scope of the disclosure as defined by any appended claims.

What is claimed is:

1. A method of creating a three-dimensional mountable object, the method comprising the steps of:
creating an inner mold configured to form a desired shape,
creating an outer mold configured to encompass at least a portion of the inner mold,
positioning a screw having a head so that the screw head lies within the inner mold,
placing a formable material inside the inner mold so that the formable material can take the desired shape and encompass at least a portion of the screw head,
applying vacuum to the formable material so as to remove bubbles from the formable material before the material hardens, and
finishing the surface of the formable material after the material has hardened.

2. The method of claim 1, wherein the finishing step comprises removing excess material from the formable material.

3. The method of claim 1, wherein the finishing step comprises painting the formable material.

4. The method of claim 3, wherein the paint includes metallic leafing.

5. The method of claim 3, wherein the painting is done by an end consumer.

6. The method of claim 1, wherein the formable material is a resin.

7. The method of claim 1, wherein the outer mold is formed of at least two parts, such that the formable material can be removed from the outer mold without breaking the outer mold upon hardening of the formable material.

8. The method of claim 7, further comprising the step of securing the outer mold parts during the hardening process of the formable material.

9. The method of claim 7, wherein the outer mold parts define an inlet for the formable material when the molds are secured to each other.

10. The method of claim 1, wherein the vacuum applying step is accomplished with the use of a controlled vacuum machine.

11. A three-dimensional mountable piece of art, the art comprising:
a resin material formed by a mold into a desired shape; and
a screw having a head end positioned to be encompassed by the resin material, wherein the resin material hardens around the screw head while the resin is held within the mold.

12. The art of claim 11, wherein the resin material has a finished surface that can be painted.

13. The art of claim 12, wherein the resin material is painted with a metallic leafing paint.

14. The art of claim 12, wherein the resin material is covered with a photo transfer.

15. The art of claim 12, wherein the resin material is painted by an end consumer.

16. A method of creating a three-dimensional mountable object, the method comprising the steps of:
creating a mold that can temporarily retain a formable material,
positioning a fastener having a submergible portion so that the submergible portion lies within the area where the formable material is retained and a second portion lies outside of the area where the formable material is retained,
placing the formable material inside the mold so as to encompass at least the submergible portion of the fastener,
applying vacuum to the formable material so as to remove bubbles from the formable material before the material forms into a solid material, and
finishing the surface of the formable material after the material has hardened.

17. The method of claim 16, wherein the mold is formed of at least two parts, such that the hardened material can be removed from the mold without breaking the mold.

18. The method of claim 16, wherein the finishing step comprises painting the hardened material.

19. The method of claim 16, further comprising fastening the mountable object to a substrate with the fastener.

20. The method of claim 19, wherein the mountable object is fastened to the substrate without the use of tools.
